(19) United States
(12) Patent Application Publication
(10) Pub. No.: US 2014/0211003 A1
(43) Pub. Date: Jul. 31, 2014

(54) SAFETY MONITORING DEVICE AND METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/153,056

(22) Filed: Jan. 12, 2014

(30) Foreign Application Priority Data
Jan. 25, 2013 (TW) 102102983

(51) Int. Cl. H04N 7/18

(52) U.S. Cl. CPC H04N 7/181
USPC 348/143

(57) ABSTRACT

An example safety monitoring method includes obtaining a password, and determining that a first total number of authorized people entered the area by increasing a count by one when the obtained password is the same as the preset password. The method then obtains a number of images captured by each camera at preset time intervals. Next, the method creates 3D models of the area corresponding to the obtained images of the area. The method then determines that a second total number of people entered the area by increasing a count by the number of people appeared in an entrance or exit of one of the 3D models which contains the highest number of people in the area. Next, the method informs each authorized people when the first total number is not the same as the second total number.

### BACKGROUND

1. Technical Field

The present disclosure relates to safety monitoring devices, and particularly, to a safety monitoring device capable of automatically informing people of danger and a related method.

2. Description of Related Art

Conventional safety monitoring devices capture images of a to-be-monitored scene, and display the captured images. Then it is needed to manually determine whether or not there are some abnormal occurrences. This not only consumes manpower, but also may result in human errors, which may cause harm to innocent people. Accordingly, there is a need for a new safety monitoring device to resolve the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a safety monitoring device, in accordance with an exemplary embodiment.

FIG. 2 is a flowchart of a safety monitoring method, in accordance with an exemplary embodiment.

### DETAILED DESCRIPTION

The embodiments of the present disclosure are now described in detail, with reference to the accompanying drawings.

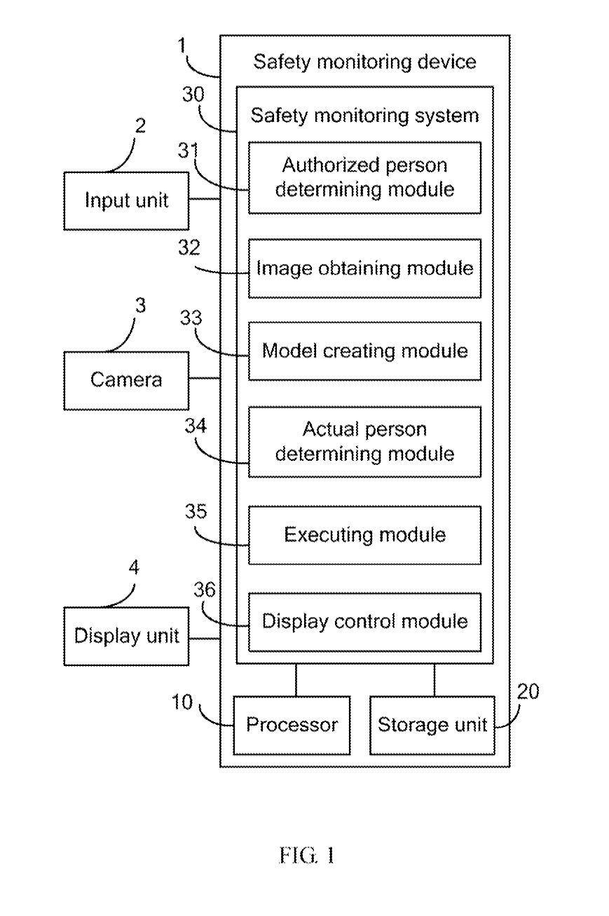

FIG. 1 shows an embodiment of a safety monitoring device 1. The safety monitoring device 1 can be used to monitor whether or not untrustworthy people enter the area to-be-monitored, such as a home or an office, for example. The safety monitoring device 1 is connected to an input unit 2 and at least one camera 3. The safety monitoring device 1 determines a first total number of authorized people entered the area (hereinafter, the first total number) according to the password input through the input unit 2. The safety monitoring device 1 further determines a second total number of people entered the area (hereinafter, the second total number) according to the images of the area captured by the camera 3. When the second total number is not the same as the first total number, it indicates that some unauthorized people may enter the area or the password has been leaked, thus the safety monitoring device 1 informs the authorized people of danger. In detail, when the second total number is greater than the first total number, it indicates that some unauthorized people may have entered the area, when the second total number is less than the first total number, it indicates that the password has been leaked. In this embodiment, the safety monitoring device 1 includes communication numbers (e.g., telephone numbers) of all the authorized people, and will send messages to all the authorized people when the safety monitoring device 1 determines that danger may happen. That is, no matter if one authorized people is in the area, the authorized person can receive the message from the safety monitoring device 1 and is made aware of the situation. In an alternative embodiment, the safety monitoring device 1 may be connected to an alarm unit (not shown), such as a speaker, for example. When the safety monitoring device 1 determines that a situation has occurred, the safety monitoring device 1 controls the alarm unit to sound an alarm. Thus, the authorized people in the area are made aware of the situation.

With such configuration, the safety monitoring device 1 can automatically determine whether or not an abnormal situation has occurred without waiting for determination made by one or more officials. Thus, the safety monitoring device 1 can not only inform the authorized people of an abnormal situation in a timely manner, but also save manpower.

The input unit 2 may be arranged on an outside of a door of the area for a user to input a password. Each authorized person will immediately use a key to open the door and then enter into the area after the input of a correct password. In this embodiment, one or more cameras 3 may be employed. To simplify the disclosure, more cameras will be described in the following. The cameras 3 are respectively arranged on entrances or exits of the area, for example, one arranged on a position adjacent to the door, and one arranged on a position adjacent to a window. In the embodiment, the camera 3 is a Time of Flight (TOF) camera. Each captured image of the area includes distance information indicating the distance between one camera 3 and each object captured by the corresponding camera 3.

The safety monitoring device 1 includes a processor 10, a storage unit 20, and a safety monitoring system 30. In the embodiment, the safety monitoring system 30 includes an authorized person determining module 31, an image obtaining module 32, a model creating module 33, an actual person determining module 34, and an executing module 35. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

In the embodiment, the storage unit 20 further stores a number of 3D models of the special person and a number of 3D models of the special entrance or exit. Each 3D model of the special person has one unique name and a number of characteristic features. Each 3D model of the special entrance or exit has one unique name and a number of characteristic features. The 3D models of the special person or the 3D models of the special entrance or exit may be respectively created based on a number of images of the special people or a number of images of the special entrance or exit pre-collected by the camera 3 and the distance between the camera 3 and the special people or the special entrance or exit recorded in the pre-collected images of the special people or the pre-collected images of the special entrance or exit. In the embodiment, each image of the special entrance or exit is pre-collected when nobody appears in the entrance or exit. The 3D models of the special entrance or exit contain each 3D model of the entrance or exit of the area.

The authorized person determining module 31 obtains a password in response to a user operation on the input unit 2, and determines whether or not the obtained password is the same as the preset password. If the obtained password is the same as the preset password, the authorized person determining module 31 determines that the first total number by increasing a count of people in the area by one. In the initial state, the first total number of person is the same as the second total number. If no password is obtained or the obtained password is not the same as the preset password, the authorized person determining module 31 determines that the first total number stays unchanged.

The image obtaining module 32 obtains a number of continuous images of the area captured by each camera 3 at preset time intervals.

The model creating module 33 creates a number of 3D models of the area corresponding to the obtained images of the area according to the obtained images of the area and the distance between each of the at least one camera 3 and each object captured by the corresponding camera 3.

The actual person determining module 34 determines the second total number according to the created 3D models of area.

In detail, the actual person determining module 34 determines whether one or more people appear in the entrance or exit of the created 3D model one 3D model by one 3D model, and compares the continuous 3D models to determine whether the number of the people appear in the entrance or exit of the 3D models is changed from zero to one or more when one or more people appear in the entrance or exit of at least one created 3D model. The actual person determining module 34 further determines the highest number of people in the area when the number of the people appear in the entrance or exit of the 3D models is changed from zero to one or more (for example, in a previous 3D model, the number of people is zero, in the current 3D model, the number of people is two, and in the later 3D model, the number of people is three), and determines the second total number by increasing a count by the highest number of people. If nobody appears in the entrance or exit of each created 3D model or the number of the people appears in the entrance or exit of the 3D models is not changed from zero to one or more, the actual person determining module 34 determines that the second total number stays unchanged.

The actual person determining module 34 determining whether one or more people appear in the entrance or exit of the created 3D model in detail includes: the actual person determining module 34 extracts data from the 3D area model corresponding to the shape of the one or more objects appearing in the created 3D area model. Compares each of the extracted data from the 3D area model with characteristic features of each of the 3D models of the special person to determine whether one or more people appear in the created 3D model of the area. If one or more of the extracted data from the 3D model of the area match the characteristic features of one of the 3D models of the special people, the actual person determining module 34 determines that one or more people appear in the created 3D model of the area. If none of the extracted data from the 3D model of the area matches the characteristic features of any of the 3D models of the special person, the actual person determining module 34 determines that nobody appears in the created 3D model of the area and accordingly nobody appears in the entrance or exit of the created 3D area model. The actual person determining module 34 further compares each of the extracted data from the 3D area model with characteristic features of each of the 3D models of the special entrance or exit when one or more people appear in the created 3D area model, to determine if the entrance or exit is covered by one or more people. If one extracted data from the 3D model of the area matches the characteristic feature of one model of the special entrance or exit, the actual person determining module 34 determines that nobody appears in the entrance or exit. If none of the extracted data from the 3D model of the area matches the characteristic feature of any models of the special entrance or exit, the actual person determining module 34 determines that the entrance or exit is overlaid by one or more people, and determines that one or more people appear in the entrance or exit.

The executing module 35 determines whether or not the second total number is the same as the first total number. If the second total number is not the same as the first total number, the executing module 35 informs each authorized person of the situation.

In the embodiment, the authorized person determining module 31 further determines whether one or more people appear in the entrance or exit of the created 3D model one 3D model by one 3D model, compares the continuous 3D models to determine whether the number of the people appear in the entrance or exit of the 3D models is changed from one or more to zero when one or more people appear in the entrance or exit of at least one created 3D model, determine the highest number of people in the area when the number of the people appear in the entrance or exit of the 3D models is changed from zero to one or more, and determine a third total number of authorized people who are in the area by subtracting a count of the determined highest number of people. The step of determining whether one or more people appear in the entrance or exit of the created 3D model is described as aforementioned. If nobody appears in the entrance or exit of each created 3D model or the number of the people appears in the entrance or exit of the 3D models is not changed from one or more to zero, the authorized person determining module 31 determines that the third total number stays unchanged.

For example, in the initial state, the number of people who is in the area is one. When a person A inputs a right password through the input unit 2, the authorized person determining module 31 determines the first total number increases by one, that is, the first total number is two. When the person A and a person B leaves the area, the authorized person determining module 31 determines that the number of people appears in the entrance or exit of the 3D models is changed from two to zero, and determines that the third total number changes from two to zero. When a person C inputs a right password through the input unit 2, the authorized person determining module 31 determines that the first total number increases by one, this is, the first total number of people changes from zero to one.

The actual person determining module 34 further determines a fourth total number of people who are in the area (hereinafter, the fourth total number) by subtracting the determined highest number of people.

The executing module 35 determines whether or not the fourth total number is the same as the third total number. If the fourth total number is not the same as the third total number, the executing module 35 informs each authorized people of situation.

In the embodiment, the storage unit 20 further records a preset greatest number of authorized people who are in the area (hereinafter, fifth total number). When the third total number is greater than the fifth total number, the executing module 35 informs each authorized person that the password has been leaked.

In the embodiment, the executing module further informs each authorized person that some unauthorized people have entered the area when the fourth total number is greater than the fifth total number.

In the embodiment, the safety monitoring device 1 is further connected to a number of display units 4. Each display unit 4 can display a 3D image. The safety monitoring system 30 further includes a display control module 36. The display control module 36 further controls the display unit 4 to display the created 3D model to each authorized person when the executing module 35 informs each authorized person of the situation, thus each authorized person can learn the condition of the area according to the displayed created 3D model.

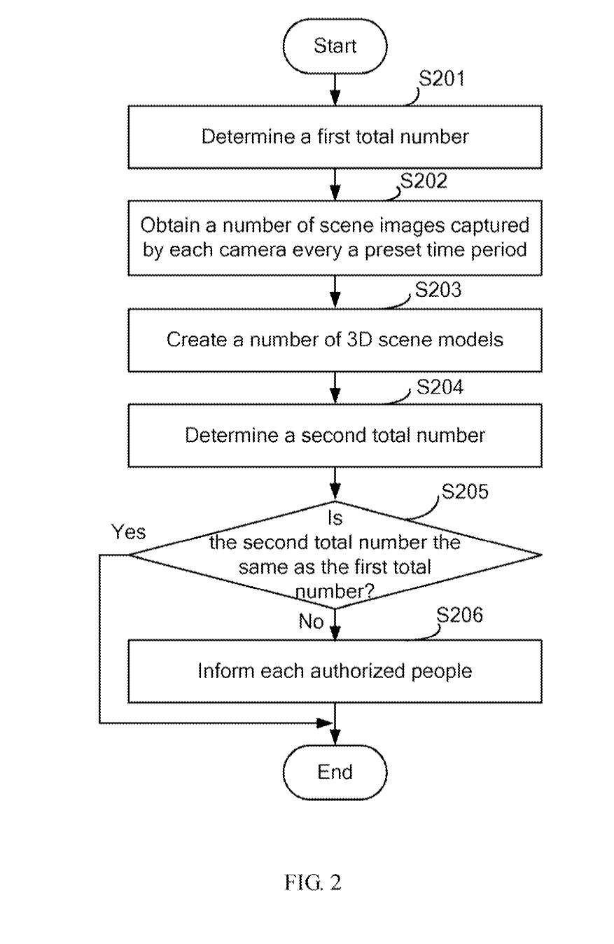

FIG. 2 shows a safety monitoring method in accordance with an exemplary embodiment.

In step S201, the authorized person determining module 31 obtains a password in response to a user operation on the input unit 2, and determines whether or not the obtained password is the same as the preset password. If the obtained password is the same as the preset password, the authorized person determining module 31 determines that a first total number by increasing a count by one. If no password is obtained or the obtained password is not the same as the preset password, the authorized person determining module 31 determines that the first total number stays unchanged.

In step S202, the image obtaining module 32 obtains a number of continuous images of the area captured by each camera 3 at preset time intervals.

In step S203, the model creating module 33 creates a number of 3D model of the area corresponding to the obtained images of the area according to the obtained images of the area and the distance between each camera 3 and each object in the field of view of the corresponding camera 3.

In step S204, the actual person determining module 34 determines whether one or more people appear in the entrance or exit of the created 3D model one 3D model by one 3D model, compares the continuous 3D models to determine whether the number of the people appear in the entrance or exit of the 3D models is changed from zero to one or more when one or more people appear in the entrance or exit of at least one created 3D model, determines the highest number of people in the area when the number of the people appear in the entrance or exit of the 3D models is changed from zero to one or more, and determines the second total number by increasing a count by the highest number of people. If nobody appears in the entrance or exit of each created 3D model or the number of the people appears in the entrance or exit of the 3D models is not changed from zero to one or more, the actual person determining module 34 determines that the second total number stays unchanged.

In step S205, the executing module 35 determines whether or not the second total number is the same as the first total number. If the second total number is the same as the first total number, the procedure stops at step S205. If the second total number is not the same as the first total number, the procedure goes to step S206.

In step S206, the executing module 35 informs each authorized person of the situation.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A safety monitoring device connected to an input unit and at least one camera, comprising:
a storage system;
a processor;
one or more programs stored in the storage system, executable by the processor, the one or more programs comprising:
an authorized person determining module operable to obtain a password in response to a user operation on the input unit, determine that a first total number of authorized people entered the area by increasing a count by one when the obtained password from the user is the same as a preset password;
an image obtaining module operable to obtain a plurality of continuous images of the area captured by each of the at least one camera at preset time intervals, each of the images comprising a distance information indicating distances between a corresponding one of the at least camera that captures the image and each object captured by the corresponding camera;
a model creating module operable to create a plurality of continuous 3D models of the area according to the obtained images of the area;
an actual person determining module operable to determine a second total number of people entered the area according to the 3D models, wherein the second total number is determined by increasing a count by the number of people appeared in an entrance or exit of one of the 3D models which contains the highest number of people in the area; and
an executing module operable to inform each of the authorized people when the first total number is not the same as the second total number.

2. The safety monitoring device as described in claim 1, wherein the actual person determining module is operable to determine whether one or more people appear in the entrance or exit of the created 3D model one 3D model by one 3D model, compare the continuous 3D models to determine whether the number of the people appear in the entrance or exit of the 3D models is changed from zero to one or more when one or more people appear in the entrance or exit of at least one created 3D model, and determine the highest number of people in the area when the number of the people appear in the entrance or exit of the 3D models is changed from zero to one or more.

3. The safety monitoring device as described in claim 2, wherein the step of “determine whether one or more people appear in the entrance or exit of the created 3D model” comprises:
extract data from the 3D model of the area corresponding to the shape of the one or more objects appearing in the created 3D model of the area, and compare each of the extracted data from the 3D area model with characteristic features of each of the 3D models of the special person, to determine whether one or more people appear in the created 3D model of the area; and
compare each of the extracted data from the 3D model of the area with characteristic features of each of the 3D models of the special entrance or exit when one or more people appear in the created 3D model of the area, determine that the entrance or exit is overlaid by one or more people when none of the extracted data from the 3D model of the area match the characteristic feature of any models of the special entrance or exit, and determine that one or more people appear in the entrance or exit of the created 3D model.

4. The safety monitoring device as described in claim 1, wherein the authorized person determining module is further operable to determine whether one or more people appear in the entrance or exit of the created 3D model one 3D model by one 3D model, compare the continuous 3D models to determine whether the number of the people appear in the entrance or exit of the 3D models is changed from one or more to zero when one or more people appear in the entrance or exit of at least one created 3D model, determine the highest number of people in the area when the number of the people appear in the entrance or exit of the 3D models is changed from zero to one or more, and determine a third total number of authorized people who are in the area by subtracting a count of the determined highest number of people; the executing module is operable to inform each authorized person when the third total number is greater than a stored preset greatest number of authorized people who are in the area.

5. The safety monitoring device as described in claim 4, wherein the actual person determining module is further operable to determine a fourth total number of people who are in the area by subtracting the determined highest number of people in the area;
the executing module is further operable to inform each authorized person when the fourth total number is greater than the stored preset greatest number of authorized people who are in the area.

6. The safety monitoring device as described in claim 1, wherein the one or more programs further comprises a display control module, the display control module is operable to control a display unit to display the created 3D model to each authorized person when the executing module is operable to inform each authorized person.

7. A safety monitoring method comprising:
obtaining a password in response to a user operation on the input unit, determining that a first total number of authorized people entered area by increasing a count by one when the obtained password from the user is the same as the preset password;
obtaining a plurality of continuous images of the area captured by each of the at least one camera at preset time intervals, each of the images comprising a distance information indicating distances between a corresponding one of the at least camera that captures the image and each object captured by the corresponding camera;
creating a plurality of continuous 3D models of the area according to the obtained images of the area;
determining a second total number of people entered the area according to the 3D models, wherein the second total number is determined by increasing a count by the number of people appeared in an entrance or exit of one of the 3D models which contains the highest number of people in the area; and
informing each of the authorized people when the first total number is not the same as the second total number.

8. The safety monitoring method as described in claim 7, wherein the step of “determining a second total number of people entered the area according to the 3D models” comprises:
determining whether one or more people appear in the entrance or exit of the created 3D model one 3D model by one 3D model;
comparing the continuous 3D models to determine whether the number of the people appear in the entrance or exit of the 3D models is changed from zero to one or more when one or more people appear in the entrance or exit of at least one created 3D model; and
determining the highest number of people in the area when the number of the people appear in the entrance or exit of the 3D models is changed from zero to one or more.

9. The safety monitoring method as described in claim 7, wherein the step of “determining whether one or more people appear in the entrance or exit of the created 3D model” comprises:
extracting data from the 3D model of the area corresponding to the shape of the one or more objects appearing in the created 3D model of the area, and comparing each of the extracted data from the 3D area model with characteristic features of each of the 3D models of the special person, to determine whether one or more people appear in the created 3D model of the area; and
comparing each of the extracted data from the 3D model of the area with characteristic features of each of the 3D models of the special entrance or exit when one or more people appear in the created 3D model of the area, determining that the entrance or exit is overlaid by one or more people when none of the extracted data from the 3D model of the area match the characteristic feature of any models of the special entrance or exit, and determining that one or more people appear in the entrance or exit of the created 3D model.

10. The safety monitoring method as described in claim 7, wherein the method further comprises:
determining whether one or more people appear in the entrance or exit of the created 3D model one 3D model by one 3D model;
comparing the continuous 3D models to determine whether the number of the people appear in the entrance or exit of the 3D models is changed from one or more to zero when one or more people appear in the entrance or exit of at least one created 3D model;
determining the highest number of people in the area when the number of the people appear in the entrance or exit of the 3D models is changed from zero to one or more, and determining a third total number of authorized people who are in the area by subtracting a count of the determined highest number of people; and
informing each authorized person when the third total number is greater than a stored preset greatest number of authorized people who are in the area.

11. The safety monitoring method as described in claim 10, wherein the method further comprises:
determining a fourth total number of people who are in the area by subtracting the determined highest number of people in the area; and
informing each authorized person when the fourth total number is greater than the stored preset greatest number of authorized people who are in the area.

12. The safety monitoring method as described in claim 7, wherein the method further comprises:
controlling a display unit to display the created 3D model to each authorized person upon informing each authorized person.

13. A storage medium storing a set of instructions, the set of instructions capable of being executed by a processor of a safety monitoring device, cause the safety monitoring device to perform a safety monitoring method, the method comprising:
obtaining a password in response to a user operation on the input unit, determining that a first total number of authorized people entered the area by increasing a count by one when the obtained password from the user is the same as the preset password;
obtaining a plurality of continuous images of the area captured by each of the at least one camera at preset time intervals, each of the images comprising a distance information indicating distances between a corresponding one of the at least camera that captures the image and each object captured by the corresponding camera;
creating a plurality of continuous 3D models of the area according to the obtained images of the area;
determining a second total number of people entered the area according to the 3D models, wherein the second total number is determined by increasing a count by the number of people appeared in an entrance or exit of one of the 3D models which contains the highest number of people in the area; and
informing each of the authorized people when the first total number is not the same as the second total number.

14. The storage medium as described in claim 13, wherein the step of “determining a second total number of people entered the area according to the 3D models” comprises:
determining whether one or more people appear in the entrance or exit of the created 3D model one 3D model by one 3D model;
comparing the continuous 3D models to determine whether the number of the people appear in the entrance or exit of the 3D models is changed from zero to one or more when one or more people appear in the entrance or exit of at least one created 3D model; and
determining the highest number of people in the area when the number of the people appear in the entrance or exit of the 3D models is changed from zero to one or more.

15. The storage medium as described in claim 13, wherein the step of “determining whether one or more people appear in the entrance or exit of the created 3D model” comprises:
extracting data from the 3D model of the area corresponding to the shape of the one or more objects appearing in the created 3D model of the area, and comparing each of the extracted data from the 3D area model with characteristic features of each of the 3D models of the special person, to determine whether one or more people appear in the created 3D model of the area; and
comparing each of the extracted data from the 3D model of the area with characteristic features of each of the 3D models of the special entrance or exit when one or more people appear in the created 3D model of the area, determining that the entrance or exit is overlaid by one or more people when none of the extracted data from the 3D model of the area match the characteristic feature of any models of the special entrance or exit, and determining that one or more people appear in the entrance or exit of the created 3D model.

16. The storage medium as described in claim 13, wherein the method further comprises:
determining whether one or more people appear in the entrance or exit of the created 3D model one 3D model by one 3D model;
comparing the continuous 3D models to determine whether the number of the people appear in the entrance or exit of the 3D models is changed from one or more to zero when one or more people appear in the entrance or exit of at least one created 3D model;
determining the highest number of people in the area when the number of the people appear in the entrance or exit of the 3D models is changed from zero to one or more, and determining a third total number of authorized people who are in the area by subtracting a count of the determined highest number of people; and
informing each authorized person when the total number of authorized people who can be in the area is greater than a stored preset greatest number of authorized people who are in the area.

17. The storage medium as described in claim 16, wherein the method further comprises:
determining a fourth total number of people who are in the area by subtracting the determined highest number of people in the area; and
informing each authorized person when the fourth total number is greater than the stored preset greatest number of authorized people who are in the area.

18. The storage medium as described in claim 13, wherein the method further comprises:
controlling a display unit to display the created 3D model to each authorized person upon informing each authorized person.
